(19) United States
(12) Patent Application Publication
(10) Pub. No.: US 2023/0247125 A1
(43) Pub. Date: Aug. 3, 2023

(54) PHONE SUPPORTS AND METHODS OF ADVERTISING

(71) Applicants: Gerald E Linden, Orlando, FL (US); Boaz Barry Groman, Boca Raton, FL (US)

(72) Inventors: Gerald E Linden, Orlando, FL (US); Boaz Barry Groman, Boca Raton, FL (US)

(21) Appl. No.: 18/128,258

(22) Filed: Mar. 30, 2023

Related U.S. Application Data
(63) Continuation-in-part of application No. 17/093,613, filed on Nov. 9, 2020, now Pat. No. 11,627,213.
(60) Provisional application No. 62/932,512, filed on Nov. 8, 2019.

(51) Int. Cl. H04M 1/04; H04B 1/3877

(52) U.S. Cl. CPC H04M 1/04; H04B 1/3877

(57) ABSTRACT

A phone support is provided as a flat sheet of card stock (or plastic) which may be folded into a 3-dimensional structure having a horizontally-extending base portion comprising two side panels (arms, wings). The phone may be supported on top edges of the side panels. Notches may be provided extending into the top edges of the side panes to receive a bottom (or side) edge of the phone. The flat sheet may be provided to a user as a template which is marked or perforated into a larger sheet of material from which the phone support may be separated. Alternatively, a flat strip of material may have notches in its top edge and may be bent (bowed, not folded) so that an edge (e.g., the long side edge) of a phone may be supported in the two notches.

### CROSS-REFERENCE TO RELATED APPLICATION(S)

This is a continuation-in part of 17/093,613 (09 Nov. 2020), which is a nonprovisional filing of 62/932,512 (08 Nov. 2019), both of which are incorporated in their entirety by reference herein.

### BACKGROUND

Phone supports (or stands) of various types are known for supporting a phone in an upright position (propping the phone up), on a bottom or side edge thereof, allowing the user to engage in hands-free calls, particularly video calls. The supports are typically made of rigid plastic, and their manufacturing cost is non-trivial. The supports are often provided in 3-dimensional form, which involves further cost for packaging and shipping.

### Some Prior Patents

US D771615 Phone stand (15 Nov. 2016; Pignotti)
US D664528 Mobile phone stand (31 Jul. 2012; Chen et al.)
US 2014/0357328 Kick It Phone Stand (04 Dec. 2014; Aharon et al)
US 2013/0270413 Portable Stand ... (17 Oct. 2013; Wilber)

### SUMMARY

Conventional phone stands can be bulky, expensive, and not environmentally friendly. There is a need for simple, lightweight, and affordable (including disposable) phone stands that can be easily made from sustainable materials.

It is an object of the invention to provide a support (or stand) for a cell phone (or similar electronic device) which is very inexpensive to manufacture, and which can be shipped in a flat (versus 3-dimensional) form.

It is a further object to provide a phone support with a number of flat surfaces which can be imprinted with information, such as advertising information, or decorative graphics.

The phone support is readily manufactured from a sheet of card stock, or plastic, such as by die cutting, which involves minimal set-up and tooling cost. Generally, card stock may be preferred.

The phone support disclosed herein can be given away as a convenience to customers, such as at a restaurant, or it can be included or integrated with another item (such as a box of breakfast cereal) as a premium, or “bonus” item.

Provided as a flat piece of card stock (or plastic), the phone support can be folded (manipulated, assembled, altered) into a 3-dimensional structure. In some embodiments, the resulting phone support may have at least two sides extending upward from a generally horizontal base portion and having a generally vertical back portion extending upward from a back of the base portion. The base portion extends as two arms (or side panels), horizontally outward from the back portion, and their distal ends may be joined with one another with tabs, slots and the like to form a stable structure, either directly or through the intermediary of flaps disposed on the (front) ends of the side panels.

The back portion may be formed by two panels extending upward from proximal portions of the respective two arms (side panels) of the base portion, forming a support having a triangular (3-sided) form. Alternatively, an additional panel may extend upward from the base portion, between the proximal portions of the two arms of the base portion, forming a support having a generally rectangular (4-sided) form. The three-sided version may be preferred.

The base portion is adapted to support a phone in an upright position, typically slightly inclined, with the bottom of the phone supported by a top edge of the base portion (top edges of the side panels) with the top of the phone resting against the back portion. The angle of the phone can readily be changed by the user, by moving the bottom of the phone along the top edge of the base portion (side panels) either closer to or further away from the back portion. The phone can be supported on the phone support either in a vertical (“portrait”) or a horizontal (“landscape”) position.

The phone support may be shipped, stocked, and provided to a user in a planar (flat) form, as a “template”, to be assembled by the user simply by folding (and connecting the tabs on the arms of the base portion). Moreover, the support may be removed by the user from an overall larger, rectangular (e.g.) sheet which has either lines printed on it for cutting out the form of the support, or lines of perforations which allow the user to tear the form of the support from the sheet. The sheet may be rectangular, such as letter size (8 ½ × 11 inches), and may be provide to the user as a table mat, or a panel of a cereal box, or the like.

After being used, the phone support can be unfolded back into its flat form for easy storage, or disposal. The material (cardboard or plastic) of the phone support may be eco-friendly.

In some embodiments, the phone support may simply comprise a generally rectangular (elongated) strip of material such as card stock or plastic having a top edge, a bottom edge, and two ends. Two notches may extend into the top edge of the strip of material, spaces apart from one another. When the strip of material is bent (or bowed) the two notches may be aligned opposite one another. A phone may be inserted, such as by its long side edge, into the two notches, which will retain the bent strip of material in its bowed configuration. The bowed strip of material will exert an elastic restorative force on the phone, tending to secure the phone in the notches. The notches may extend either vertically (perpendicularly) the top edge of the strip, or may be inclined towards a midpoint (centerline) of the strip.

A phone may also be supported in a vertical orientation on the bowed strip phone support. alternatively, a phone may be supported in a vertical orientation on a surface such as a tabletop, with the support engaging a long (vertical) side edge of the phone and providing stability to the vertically oriented phone.

Other objects, features and advantages of the phone support disclosed herein may be ascertained from the following descriptions of various embodiments thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

FIG. 1 is a diagram (plan view) of a template of a four-sided support, according to an embodiment of the invention. This diagram also illustrates one way that flaps may be provided at the distal (front) ends of the side panels (arms, wings), and the flaps may have tabs and slots to connect with each other. The top edges of the side panels are wavy. Notches may be formed in the bottom edges of the side panels.

FIG. 2 is a diagram (plan view) of a template of a three-sided support. according to an embodiment of the invention. This is essentially the same as the four-sided embodiment (FIG. 1), but without the back panel. Rather, the two side panels are joined with each other, at the centerline, by their back edges, and the back of the support is formed by two panels extending upward from the back portions of the side panels.

FIG. 3A is a diagram (plan view) of an exemplary one of two side panels (arms, wings) having a straight top edge.

FIG. 3B is a diagram (plan view) of an exemplary one of two side panels (arms, wings) having a straight top edge which is angled from front (distal end) to back (proximal end).

FIG. 3C is a diagram showing how one (right side) front flap may have a single slit extending in from its bottom edge, and the other (left side) front flap may have one or more slits extending in from its top edge. With two slits extending into the to edge of the left side front flap, the two flaps may be engaged in two different positions to make the base of the support wider or narrower.

FIG. 4 is a diagram of a typical one of two (typically identical, mirror-images of each other) side panels for the phone support, and also shows a cell phone for being disposed on the top edges of the side panels. This side profile is generally applicable to either three-sided (“triangular”) of four-sided (“rectangular”) phone supports.

FIG. 5A shows a template for a three-sided (“triangular”) phone support which is defined by tear-out lines (or lines of perforations) in a larger, typically rectangular piece of card stock, which may, for example, be a place mat. Rather than having perforations, the outline of the template may be printed, and the template may be cut out by the user (such as with scissors).

FIG. 5B shows a template for a four-sided (“rectangular”) phone support which is defined by tear-out lines (or lines of perforations) in a larger, typically rectangular piece of card stock, which may, for example, be a place mat. Rather than having perforations, the outline of the template may be printed, and the template may be cut out by the user (such as with scissors).

FIG. 6A is a side view of a V-fold Tablet Stand, and FIG. 6B is a perspective view of a tablet being supported by the V-fold Tablet Stand of FIG. 6A, according to the prior art.

FIG. 7 is a diagram of a template for an exemplary phone support which is defined by tear-out lines (or lines of perforations) in a larger, typically rectangular piece of card stock, which may, for example, be a place mat, according to an embodiment of the invention.

FIGS. 8A,B are illustrations (plan view) of a single piece support for a phone (e.g.) having notches (grooves) into which a side edge of a phone may be inserted, according to an embodiment of the invention. FIG. 8B shows angled notches, which could be incorporated in the FIG. 8A embodiment. FIG. 8B is also higher at the middle of the single piece to provide additional surface area for advertising (text, logos, etc.). The back need not be sufficiently high to support the back of a phone inserted into the grooves, as it is generally intended that the grooves themselves provide sufficient support for the phone.

FIGS. 8C,D are photographs (two different views) of a phone inserted horizontally in the notches (grooves) of a single piece support which is resting on a surface such as a tabletop, according to an embodiment of the invention. In this embodiment, the single piece support may be bent (bowed) rather than folded. A middle portion of the support may be higher and the notches may be angled, in the manner illustrated in FIG. 8B.

FIG. 8E is a diagram of a phone inserted vertically (by its short bottom edge, in “portrait mode”) into the grooves of a single piece phone support, such as the support shown in FIG. 8B (with angled grooves), with the support resting on a surface such as a tabletop, according to an embodiment of the invention. In this example, the support may be bent (bowed) rather than folded. However, it is evident that due to the high center of gravity of the phone, this use of the phone support may not be practical, and may require that the grooves be sized to tightly fit the phone, and that when the phone is supported in this manner, the top of the phone does not overhang the back of the support.

FIG. 8F is a photograph of a phone resting vertically (by its short bottom edge, in “portrait mode”) on a tabletop. In contrast with most or all of the other examples shown and described herein wherein the weight of the phone is on the support which is on a surface (tabletop), in this example the bottom (short) edge of the phone is resting on the surface (tabletop), and the notches of single piece (bowed) phone support (such as the support shown in FIG. 8B) engage the vertically-oriented long edge of the phone, with an end of the support also contacting the surface (tabletop), in what might at best be termed a “balancing act”, according to an embodiment of the invention.

FIG. 9 is a photograph of a single piece support for a phone (e.g.), according to an embodiment of the invention. In this embodiment, the single piece support may be bent (bowed) rather than folded. A middle portion (above the dashed line) of the support may be higher, in the manner illustrated in FIG. 8B. The notches may be partially angled. The middle portion has a length (end -to-end) which is less than the length of the overall support. End portions (or extensions) of the middle portion of the support may be provided with “flaps” (or tabs) which are shown folded 90° towards the back of the support, forming what could be termed “extensions” of the respective grooves, which provide additional contact area between the phone and the support and thereby aid in the “mating” of phone and support.

FIG. 9A is a photograph (front view) of a phone being supported vertically on a support, such as the support of FIG. 9, according to an embodiment of the invention.

FIG. 9B is a photograph (front view) of a phone being supported vertically on a support, such as the support of FIG. 9, according to an embodiment of the invention.

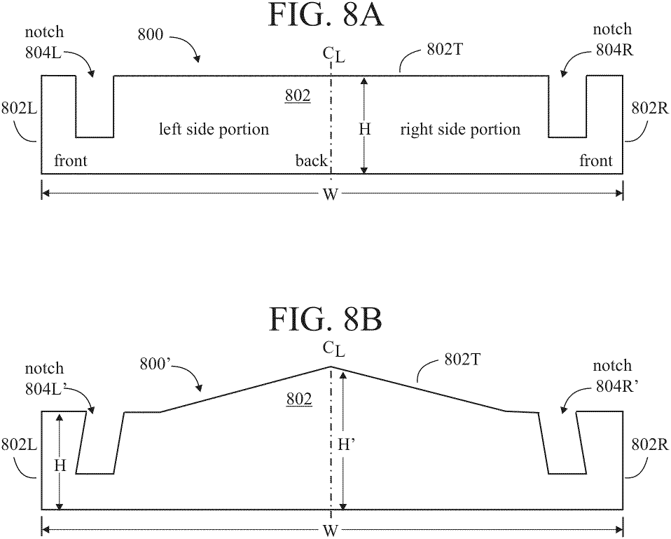

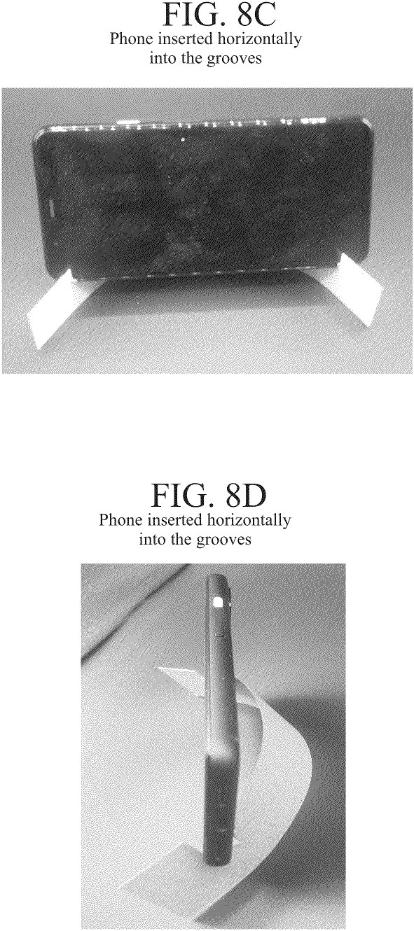

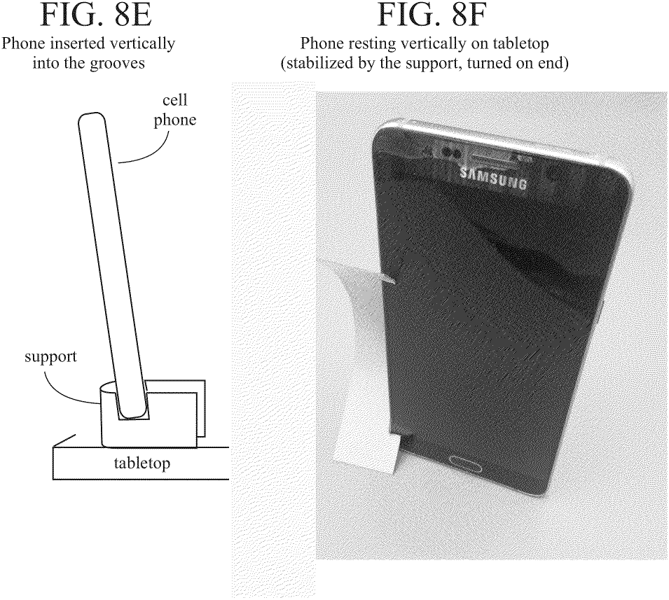

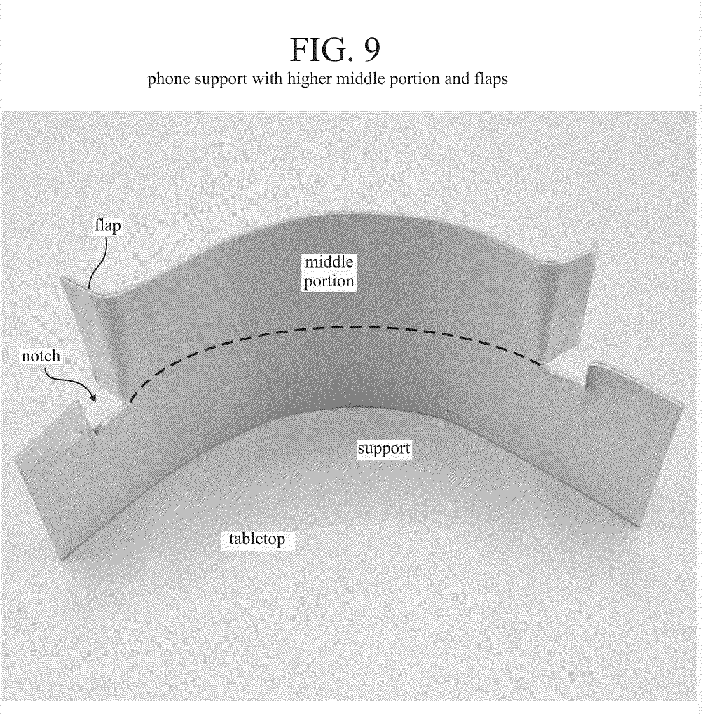

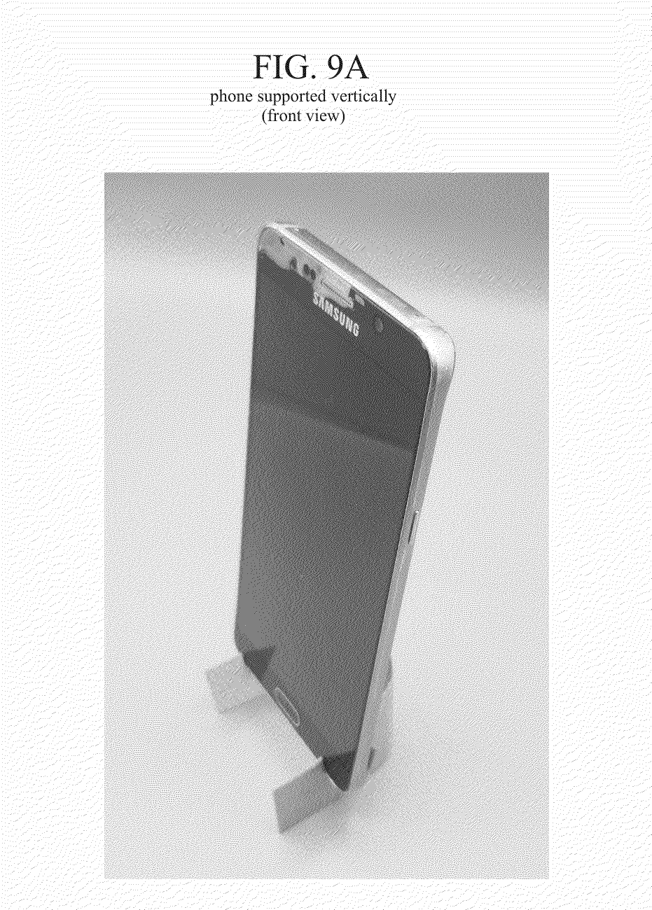

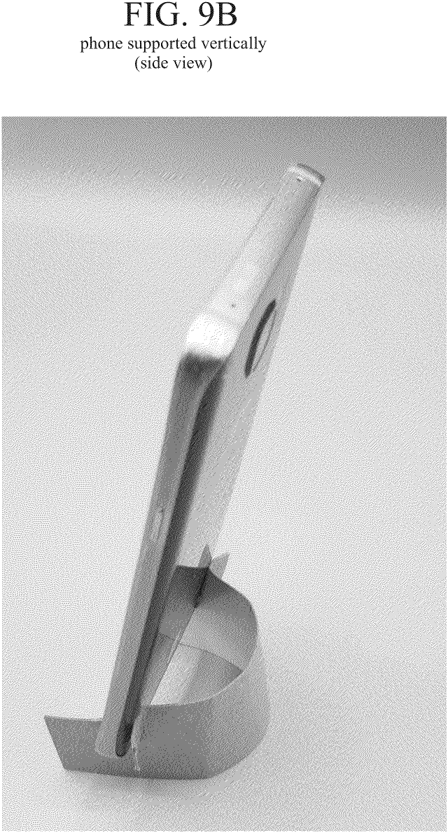

A phone being supported horizontally by a single piece phone support with “flaps”, such as in the FIG. 9 embodiment, would look much like the arrangement (phone horizontal) as was shown in FIGS. 8C and 8D.

### DETAILED DESCRIPTION

A flat piece of plastic or cardboard has a specific form (outline), and may be referred to as a “template” (or “sheet”, or “substrate”). The template includes various surfaces and edges, and features such as fold lines, notches and tabs.

When assembled (folded), a support for a cell-phone is provided having a base portion and a back portion extending up from the base portion.

Two versions are disclosed herein:
a four-sided (“rectangular”) version
a three-sided (“triangular”) version

Both versions have:
a base portion extending horizontally from a back of the support to the front thereof
a back portion extending vertically upward from the back of the support

The base portion comprises:
two horizontally-oriented side panels (or arms, or wings) extending outward (typically forward, towards the user) from the back of the support and having (i) lower edges for resting on a surface (such as a table) and (ii) upper edges for supporting the phone resting on the support.

The overall support may have a height of a few inches (2″ - 4″; 5 - 10 cm).

The base portion may have a height of a few centimeters (2 - 4 cm). This will create a small “chamber” at the bottom of the support which may amplify sound coming from the bottom of the phone (assuming that the phone’s speaker is disposed at the bottom of the phone).

The phone may be supported in an upright (portrait) orientation, or a sideways (landscape) orientation on the upper edges of the base arms (side panels) and, in either case, the phone may be leaned (angled) slightly backwards against the back portion of the support. The bottom (or side) of the phone which is supported on the upper edges of the support arms may be positioned closer to or farther away from the back portion to adjust the angle of the phone.

Since the phone may be angled (not quite vertical), it may tend to slide off of the front (distal end) of the base portion. This (sliding) can be inhibited by the top edges of the base arms being angled slightly downward from their distal ends (away from the back portion) to their proximal ends (where they meet/join with the back portion). The angle may be a few (1-10) degrees. This (sliding) can be prevented (prohibited) by providing “bump” (curb) features extending upward from the top edges of the base arms at or near their distal ends.

The back portion may have forward-oriented edges that are vertical. Alternatively, the forward-oriented edges of the back portion may be nearly vertical, or angled, from where the back portion joins with the base portion, backwards, towards the top of the back portion. The angle may be a few (1-10) degrees.

### Four-Sided (Rectangular)

In this configuration, the base portion has:
a left side panel (or arm),
a “flap” extension at the distal end of the left side portion, and
a right side panel (or arm), a “flap” extension at the distal end of the right side portion which, when folded and assembled, may be joined to the flap extension of the left side portion to form a front panel of the base portion. A back portion of the base portion may be contiguous with the upwardly-extending back portion of the support.

Top edges of the side portions (arms) support the weight of the phone, which rests at an angle against the vertical back portion.

The top edges of the side portions (or arms) may be “wavy” to “capture” the lower edge of the phone, allowing it to be supported at various angles, and preventing it from sliding down when it is resting against the back portion.

The template may very easily be assembled (fold, connect free ends) by an end-user.

The resulting cell-phone support has ample flat surfaces for graphics (advertising), and is very inexpensive to produce.

The support may be provided to the end-user either as a flat template, or already assembled.

The support may be included with corporate give-aways (pens, etc.).

The support may be cut from a sheet of plastic, and may be provided to the end-user either as a flat template, or already assembled.

The template may be provided as a flat sheet of cardboard (or card stock), die-cut so that the end user can separate the template from the sheet, then assemble it. A flat, unassembled template may, for example, be provided as a “premium” item on a panel (such as the back panel) of cereal boxes, and the like. The template may be printed or pre-punched on the box panel.

A “regular” size template may be used to form a support for a cell-phone.

A “large” size template may be used to form a support for a tablet.

A support structure for a cell-phone may comprise:
a flat substrate (such as plastic or cardboard), has a specific form (outline), and may be provided with fold lines (or welts, or the like), notches and tabs, and some other features (refer to illustrations);
the substrate (or “template”) may assembled (folded) by an end-user to form a 3-dimensional support structure from the flat template.

Graphics (such as advertising, team logos, etc.)may be provided on surfaces of the template (and resulting support structure).

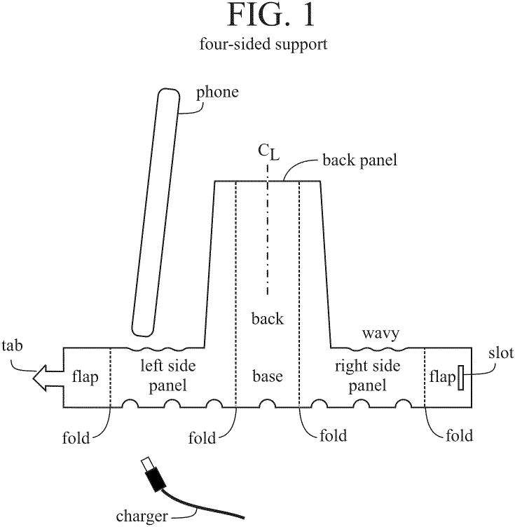

The left and right ends (end flaps extending from respective left and right side panels) may form the front of a base for the support, and may be overlapping and/or connected with one another in any suitable manner, such as the illustrated tab/notch (FIG. 1) or, in the case of cardboard, the overlapping ends may be stapled to one another. Another alternative is one flap has a slit extending from its top edge, the other flap has a slit extending from its bottom edge, and the flaps are overlapped, inserted into each others’ slits.

### Some Embodiments

FIG. 1 is a diagram (plan view) illustrating a “four-sided” phone support, flat, not folded, according to an embodiment of the invention. Notice that the top edges of the side panels (arms, wings) may be “wavy”, to allow the bottom edge of the phone to be securely positioned at various distances from the back of the support, thereby allowing “stepwise” adjustments to the angle of the phone as it is resting on the support.

This (wavy top edge) represents a feature on the top edges of the base portion. A similar feature is to have one or two bumps (or “stops”) protruding upward to limit the forward position of the bottom of the phone with it is resting on the support. Another feature is that the top edges (when assembled) of the base portion may be angled downward from the front of the support to the back.

This diagram also illustrates one way that flaps may be provided at the distal (front) ends of the side panels (arms, wings), and the flaps may have tabs and slots to connect with each other. The top edges of the side panels are wavy.

Notches may be formed in the bottom edges of the side panels to allow, for example, a charger cable to be plugged into the bottom of the phone when it is resting on the support.

The base may be provided with a bottom surface (not shown), which can be formed by additional extension portions of the template (such as extensions of the side panels), forming a open-top “box” where ear buds and the like can be stored (when assembled). Alternatively, the base may be left open.

The base may be high (tall) enough to allow a charger cable to enter the structure (through the notches on the bottom edge), and connect to the phone. A right-angle USB connector (female to male) may be provided, to avoid kinking the charger wire. However, this would be antithetical to the object of “keeping it simple”. Generally, a one piece foldable structure, as disclosed herein, may be preferred.

The base forms a “chamber” which may amplify sound coming from the phone’s speaker. This may be true whether the base is closed, or open and sitting on a surface (table).

Ear buds and the like may be stored in the base.

The template may be formed with a strap extending across the base, or with other tabs or slots disposed along sides of the base, for accepting something like coins, to add weight to the assembled structure to add stability to the whole thing (support with phone sitting on it), thereby minimizing tipping over.

The template may be extremely inexpensive to produce (in some cases, requiring only modifying the dies for cutting the already existing cardboard), and may be flat (FIG. 1).

The support structure may be disassembled (unfolded) for easily carrying, such as in a book-bag, or portfolio, or briefcase. Or even in a user’s pocket (such as a jacket pocket)

The support structure may be made available, in its flat un-assembled form (i.e., the “template”) to customers of establishments such as McDonalds, or Starbucks, where they may want to relax, have something to eat or drink, and use their phone. The template could be defined by perforations in a standard rectangular flat sheet of material (e.g., card stock), and would, of course, be printed with advertising.

Some exemplary approximate dimensions may be as follows. The base portion may be 2-3 cm high. The width of the base portion (between the two side portions) may be 4-6 cm. The back portion may extend vertically 8-10 cm above the base portion. The back portion may have a width of 2-4 cm. The base portion may extend horizontally 4-6 cm from the back portion.

FIG. 1 shows a the flat “template” for the phone support, prior to folding (assembling). Various fold lines are shown, also a centerline (CL). A phone is shown, for reference (perspective). A charger cable is shown, for reference (perspective).

The template for the phone support may be delivered to the user as a flat, rectangular sheet with lines printed on the sheet, or lines of perforations punched into the sheet, to allow the user to separate the template from the overall sheet. The sheet may suitably be a “place mat” supplied by a restaurant to the user, containing advertising information, or a menu, etc.

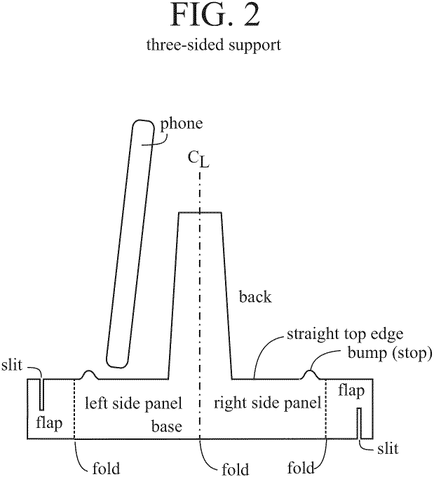

FIG. 2 is a diagram (plan view) of a template of a three-sided support. This is essentially the same as the four-sided embodiment (FIG. 1), but without the back panel. Rather, the two side panels are joined with each other, at the centerline, by their back edges, and the back of the support is formed by two panels extending upward from the back portions of the side panels.

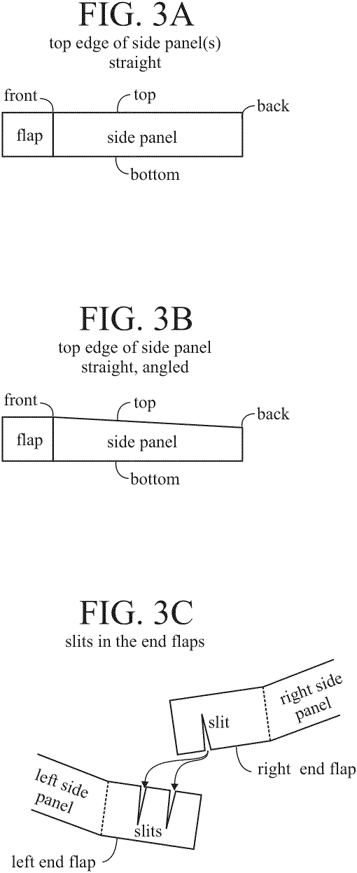

This embodiment illustrates slits in the flap extensions of the side panels for assembling the support, in the manner shown in FIG. 3C (below). This embodiment also shows bumps (stops) extending upward from near the front (distal) ends of the side panels.

FIG. 3A is a diagram (plan view) of an exemplary one of two side panels (arms, wings) having a straight top edge.

FIG. 3B is a diagram (plan view) of an exemplary one of two side panels (arms, wings) having a straight top edge which is angled from front (distal end) to back (proximal end).

FIG. 3C is a diagram showing how one (right side) front flap may have a single slit extending in from its bottom edge, and the other (left side) front flap may have one or more slits extending in from its top edge. With two slits extending into the to edge of the left side front flap, the two flaps may be engaged in two different positions to make the base of the support wider or narrower.

FIG. 3C shows that flaps at the distal (away from the back) ends of the left and right sides of the base may be provided with slits or the like to facilitate joining the sides together when assembling the flat template into a 3-dmiensional phone support.

FIG. 3C shows that the left end flap (extension of the left side panel) is provided with two notches extending into the flap from its top edge, and the right end flap (extension of the right side panel) is provided with a single notch extending into the flap from its bottom. In this manner, the end flaps may be overlapped and joined together at two different positions to determine two different widths for the front of the support. e left and right end flaps may be provided with notches, such as illustrated in FIG. 1A, so that they may be connected.

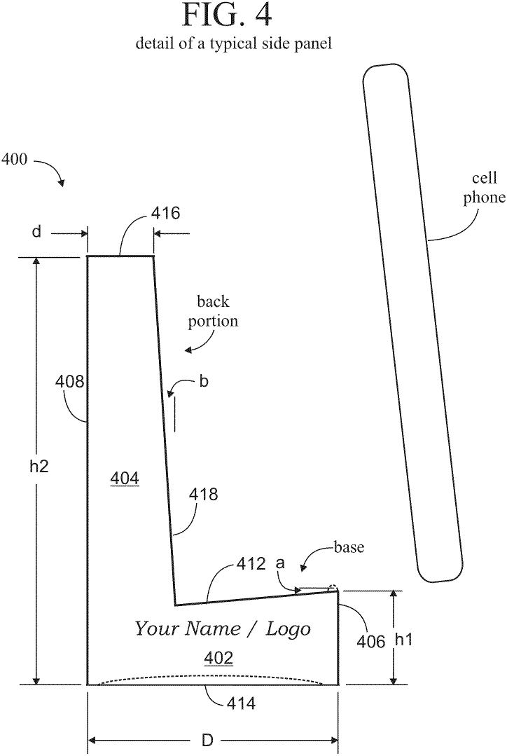

FIG. 4 is a diagram of a typical one of two (typically identical, mirror-images of each other) side panels for the phone support, and also shows a cell phone for being disposed on the top edges of the side panels. This side profile is generally applicable to either three-sided (“triangular”) of four-sided (“rectangular”) phone supports.

From the side, the support 400 is generally L-shaped, having a generally horizontal base portion formed by side panels (one shown) 402 and a generally vertical back portion 404. The flap extensions of the side portions

The base portion may be considered to extend all the way from the front edge 406 of the support to the back edge 408 of the support, and may have a height “h1” at its front edge (distal from the back) and a height h2 at its back edge (or proximal to the back). The base portion may be slightly (such as a few millimeters) higher at the front than at the back so that its top edge 412 is slightly angled towards the back, such as with an angle “a” of a few degrees, to counteract a tendency for the phone to slide down and off of the support. Alternatively, the top edge of the base portion may be wavy, or it may have a “stop” (or “curb) disposed near its front edge and extending slightly (such as a few millimeters) upward to prevent the phone from sliding off. A phone support made from card stock will also exhibit some friction to prevent this from happening, whereas a phone support made from plastic may have much less friction.

A bottom edge 414 of the base portion may be flat, or it may be slightly (such as a few millimeters) “relieved” (dashed line) to ensure that the support can rest stable on a slightly uneven surface. Indeed, a triangular support may have substantially only three points of contact with the underlying surface. (A four-sided support would have four points of contact.)

The back edge 408 of the support may be substantially vertical. The overall height “h2” of the support may be approximately 10 cm, as measured from its bottom edge 414 to its top edge 416. The overall depth “D” (horizontal dimension, from back-to-front) of the support may be approximately 5 cm, as measured from the back edge 408 to the front edge 406. A width of the support, from the front distal edges of the two side panels (wings, arms) is not shown in this side view, but may be approximately 2 - 5 cm.

Front edges 418 of the (two) panels forming the back portion 404 may be slightly angled, from front-to-back, resulting in an angle “b” (such as a few degrees) from vertical. This is to ensure that the phone is resting securely against the back. Else, the phone may tend to tip forward, if disturbed. The back edges of the side panels would be joined with one another in a three-sided version (e.g., FIG. 2). The back edges of the side panels would be joined to edges of a back panel in a four-sided version (e.g., FIG. 1).

The back may or may not come to a point. In FIG. 4, it is shown that the top edge 416 of the back portion may have a depth “d”, such as a few millimeters, from the top of its front edge 418 to the top of its back edge 408. Note that the front edge is tapered.

The side panel, per se, may have a height of “h1” at its front (right, as viewed), and a height of “h2” - “h1” at its back (left, as viewed), and a length of “D” or “D” - “d”. An advertising message (“Your Name / Logo”) is shown on the side panel. Advertising may be located on any or all of the surfaces of the phone stand in any of the embodiments disclosed herein.

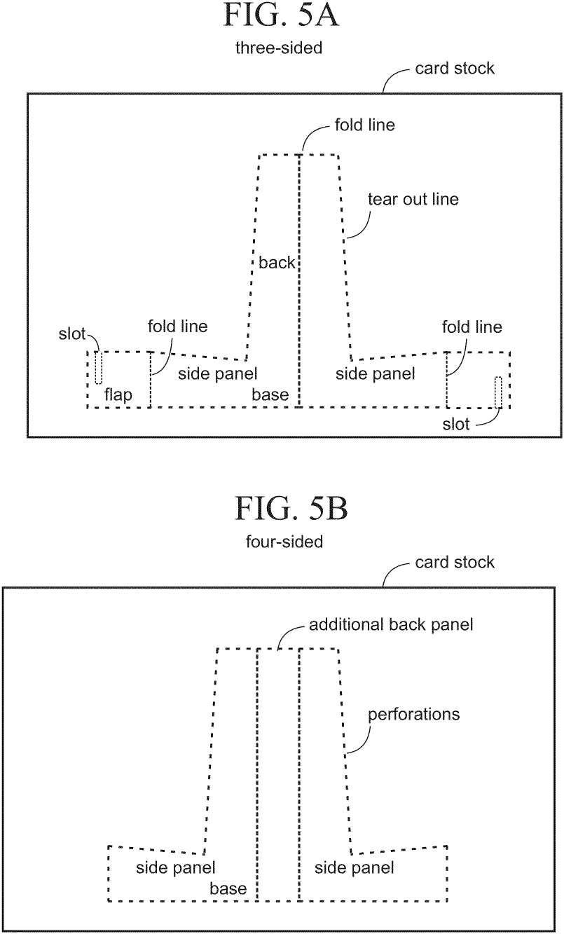

FIG. 5A shows a template for a three-sided (“triangular”) phone support which is defined by tear-out lines (or lines of perforations) in a larger, typically rectangular piece of card stock, which may, for example, be a place mat. Rather than having perforations, the outline of the template may be printed, and the template may be cut out by the user (such as with scissors).

FIG. 5B shows a template for a four-sided (“rectangular”) phone support which is defined by tear-out lines (or lines of perforations) in a larger, typically rectangular piece of card stock, which may, for example, be a place mat. Rather than having perforations, the outline of the template may be printed, and the template may be cut out by the user (such as with scissors). Front end flaps for joining the distal ends of the two base sides (arms) together, are omitted, for illustrative clarity.

FIGS. 5A,B both show that the template for the phone support may be defined by lines of perforations (tear out lines) which are formed (or printed) in a larger piece (substrate) of card stock (for example) which may be how the support is supplied to the end-user. The larger substrate may, for example, be a place mat, or a panel of a cereal box, or simply a suitably sized rectangular piece of card stock provide to the user in any suitable format.

### Some Additional Disclosure

Some additional disclosure will now be presented, without prejudice. Some of the matter in this “additional” disclosure may already be present in the disclosure(s) of parent 17/093,613.

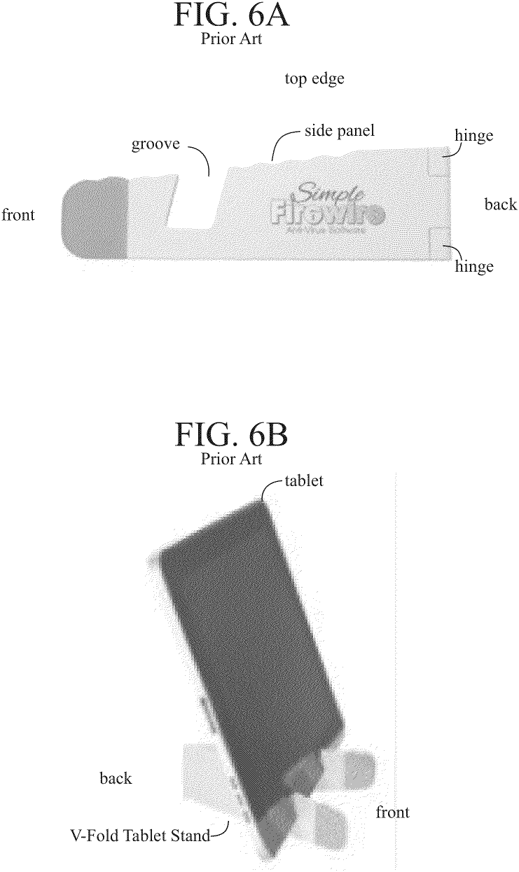

FIGS. 6A and 6B show a V-fold Tablet Stand, according to the prior art, such as may be found at https://www.qualitylogoproducts.com/custom-phone-stands-and-holders.htm.

The V-fold Tablet Stand has what appears to be two elongate side panels, joined with one another at their “back” ends, apparently by one or more hinges (FIG. 6A; “hinges?”). Each of the two side panels has a notch in its top edge receiving a tablet.

A tablet is shown inserted by its bottom end into the notches on the top edges of the side panels, and allowed to incline backwards until restrained by the side panels. Front end portions of the side panels of the V-fold Tablet Stand are “free” (i.e., not joined with one another), and are provided with non-skid rubber tips.

As touted in the text accompanying the illustration of the V-fold Tablet Stand, Tablets are wonderful pieces of technology. But they do have one drawback: they’re impossible to stand up to watch a movie or video. But you can solve that problem by giving your customers a personalized V-Fold Tablet Stand from Quality Logo Products®! These stands will make tablet use easier and give your brand some exposure!

The V-Fold Tablet Stand from Quality Logo Products® features:

Made of sturdy plastic with non-skid rubber tips
Folds up to slim profile that’s perfect for handouts or mailings
Holds a variety of tablets
Perfect for electronic stores, repair shops, and software companies
Simply open the stand, put your tablet in the grooves, and start using your device! It’s great for watching long videos or movies or playing an intense game. It’ll save your customers from tired arms and help you leave a lasting impression. So leave your mark for less when you call and order from Quality Logo Products® today!

Customers love to shop our Custom V-Fold Tablet Stands and enjoy the guaranteed lowest price on Custom Cell Phone Stands & Custom Phone Holders from Quality Logo Products®

The V-Fold Tablet Stand may be marketed by Quality Logo Products Inc. (724 North Highland Avenue, Aurora, Illinois 60506; phone 866-312-5646) and appears to be carrying advertising for “Simple Firewire Anti-Virus Software” on one of its side panels.

Applicant’s phone support (stand) may similarly display advertising on its side panels (or portions).

Applicant’s embodiments of phone stands, both in the parent application and in this continuing application are readily distinguishable from the aforementioned V-Fold Tablet Stand. Among other things, the V-fold Tablet Stand does not have a back panel against which the tablet (or phone) may rest. With the V-fold Tablet Stand, the tablet (or phone) must be positioned in the grooves of the side panels, and will be supported at a unique predetermined angle.

In some embodiments of Applicant’s phone stand, the phone (or tablet) may be positioned at various positions along the top edges of the side panels, and leaned (tilted) at various angles against the back panel (4-sided embodiments) or portion (3-sided embodiments) to adjust the viewing angle (the angle at which the phone is supported on the support).

In the embodiments of Applicant’s phone stand described hereinabove (e.g., FIGS. 1-5), the front ends of the side panels may be joined with one another, to stabilize the phone stand by keeping the front ends of the side panels at a predetermined distance from one another.

All of the embodiments disclosed herein are well-suited to supporting a phone in a horizontal (landscape) orientation.

The embodiments having a back panel (e.g., FIGS. 1-5) are particularly well suited to additionally supporting a phone in a vertical position. Applicant’s back panel (or portion) extends a significant distance upward from the back of the side panels (or base portion), such as approximately at least 2 ½ inches or 6 centimeters, or at least half the height of a typical phone — for example, half of 5 inches or 12 centimeters, so that it may adequately support a phone resting nearly vertically on the top edges of the side panels. The back portion (or panel) should extend at least 2 cm above the top edge(s) of the side panel(s). Using FIG. 4 as an example, the back portion extends a distance h2 (overall height, including back panel or portion) minus h1 (height of the side panel) above the top edge of the side panel.

The V-fold Tablet Stand of the prior art has two discrete (separate) side panels joined with one another at their back ends by what appears to be discrete hinges (see FIG. 6A; “hinges”).

Applicant’s phone support described hereinabove (FIGS. 1-5) has two side panels formed from the same single piece of material (e.g., card stock) and joined with one another at their back ends by a “living” hinge. To assemble the support into a 3-dimensional form from its initial flat form (“template”), the side panels are folded towards one another about a centerline (FIG. 2) or about a back panel (FIG. 1).

During the prosecution of the parent application (17/093,613), the claims were rejected under 35 USC §102 and §103 over Wilber (US 2013/0270413). An Amendment was filed (20 Sep. 2022) with arguments distinguishing Applicant’s phone stand from Wilber’s phone stand, some claims were amended, and some new claims were presented. The application was allowed.

Applicant’s phone stand is distinguishable from Wilber in at least the following respects:
Wilber is formed from a sheet of laminate material, such as two outer layers having sandwiched therebetween and bonded thereto an inner layer of polymeric material.
Applicant’s material is a flat sheet of card stock or cardboard (Abstract)
Wilber’s base section is mostly flat, planar, not having a “z-axis” dimension.
Applicant’s base portion extends as two arms (side panels), horizontally outward from the back portion. The phone is supported on top edges of the side panels:
The top edges of Applicant’s side panels (arms, wings) may be “wavy”, to allow the bottom edge of the phone to be securely positioned at various distances from the back of the support
A phone supported by Wilber will have its bottom edge (or short side) disposed nearly against the surface (e.g., tabletop) upon which the support is disposed.
Applicant’s “3-dimensional” base portion provides a resonating cavity. The base forms a “chamber” which may amplify sound coming from the phone’s speaker. Ear buds and the like can also be “stored” in the chamber.
Wilber has a foot stop 28 that can be pivoted upwards to restrain the device from sliding downwards from the inclined position.
Applicant does not require a “foot stop” extending upward from the base portion to keep the phone from sliding downwards from its inclined position. Rather, various features may be provided on the top edges of the base portion (i.e., top edges of the side panels) to inhibit or prevent the phone from sliding off of the support. The top edges of the side panels may be wavy. The side panels may have a straight top edge which is angled from front (distal end) to back (proximal end) to counteract a tendency for the phone to slide down and off of the support.

### Some “Improvements” to the Embodiments in Parent 17/093,613

Firstly, Applicant would like to clarify (“update”, elaborate upon) some terminology. For example, FIG. 2 is a diagram (plan view) of a template of a three-sided support, and FIG. 5A shows a template for a three-sided (“triangular”) phone support which is defined by tear-out lines (or lines of perforations) in a larger, typically rectangular piece of card stock, which may, for example, be a place mat. FIGS. 1 and 5B, showing four-sided (“rectangular”) supports are also relevant.

In both of these exemplary embodiments (FIGS. 2, 5A), the phone support (or stand) comprises:

a flat sheet of cardstock suitable to be assembled by folding into a 3-dimensional structure, wherein the assembled structure comprises:
two side panels, each having back edges, distal ends opposite the back edges, top edges and bottom edges, wherein the two side panels are joined with each other at their back edges;
a generally vertical back portion extending upward from the top edges of the side panels; and
flaps extending from the distal ends of the side panels, and capable of being connected with one another;
wherein, in use, top edges of the side panels support a phone.

Reference may be made to independent newly-presented claim 21 in the amendment of September 2022.

Regarding the “flaps”, it should be evident that the “flaps” may simply be extensions or end portions of the respective side panels from which they extend, and may later be joined together (such as shown in FIG. 3C).

The flaps, or distal (front) end portions of the side panels may be joined in various ways with one another to stabilize the assembled phone support (phone stand). For example, as set forth in claim 23 of the September 2022 amendment,
the flap of one side panel has a slit extending downward from a top edge thereof; and
the flap of the other side panel has a slit extending upward from a bottom edge thereof.

In the exemplary triangular embodiments of FIGS. 2 and 5A, the back ends of the two side panels are contiguous with one another. When the phone support is assembled, the two side panels are joined with one another at their front ends by the so-called “flaps”, resulting in a typically acute angle formed between the two (“left” and “right”) side panels.

Reference may be made to FIG. 2 which illustrates slits in the flap extensions of the side panels for assembling the support, in the manner shown in FIG. 3C. Note that the flap of the “left” side panel in FIG. 3C has two slits, allowing the side panels to be joined at two different angles, depending on into which of the two slits the one slit in the “right” side panel is inserted.

The aforementioned V-fold Tablet Stand (FIGS. 6A,B) has two side panels, joined at their back ends and their front ends are not joined with one another. Apparently, the V-fold Tablet Stand is made of a very stiff material, such as plastic or aluminum, and once the side panels are unfolded and a tablet is inserted by its bottom end into the notches (grooves) on the top edges of the side panels, the side panels will tend to remain immobilized with an angle therebetween.

This indicates that if Applicant’s phone support (or stand) is made from suitably stiff material, the flaps at the front ends of the side panels may be superfluous (not necessary).

Hence, a “flapless” variation of the earlier (FIGS. 1-5) embodiments of Applicant’s phone support (or stand) may be characterized as:
a flat sheet of cardstock suitable to be assembled by folding into a 3-dimensional structure, wherein the assembled structure comprises:
two side panels, each having a back (proximal) end, a front (distal) end opposite the back edges, a top edge and a bottom edge, wherein the two side panels are joined with each other at their back ends forming a living hinge); and
a generally vertical back portion extending upward from the top edges of the side panels;
wherein, in use, the top edges of the side panels support a phone.

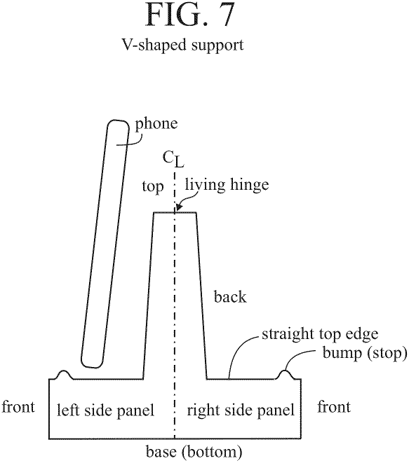

FIG. 7 shows a phone support which is similar to the phone support shown in FIG. 2. However, the FIG. 7 phone support does not have flaps at the distal (front) ends of the side panels.

In the FIG. 2 and FIG. 7 embodiments, left and right side panels may be formed from a single piece of material such as card stock, and a “living hinge” is formed between the two side panels. Additionally, back portions extending upward from the rear of the side panels may be formed from the same single piece of material, and a “living hinge” is formed between the two back portions at the centerline (CL).

A living hinge or integral hinge is a thin flexible hinge (flexure bearing) made from the same material as the two rigid pieces (in this example, the side panels) it connects. It is typically thinned or cut to allow the rigid pieces to bend along the line of the hinge. The living hinge connecting the two side panels may be thinned or provided with some cuts to facilitate folding the side panels towards each other (without causing deformation of the side panels) when assembling the support.

In the FIG. 2 and FIG. 7 embodiments, a phone is shown (in cross-section) being supported on top edges of two spaced-apart (spread out) side panels. (FIG. 4 also shows a phone ready to be supported.) The phone (or cell phone, or mobile phone) is representative of any electronic device (such as a tablet) sought to be supported in an upright position, on one of its four sides (or edges). Typically, the phone would be supported at its bottom edge where (typically) the charging port and speaker may be located.

A typical cell (mobile) phone is in the form of a generally rectangular solid (“brick”), having two opposite long sides (or side edges) measuring approximately 6 inches (15 cm), two short sides (or top and bottom edges) measuring approximately 3 inches (7.5 cm) and a thickness of approximately 3/16 inch (0.5 cm).

The FIG. 7 embodiment may be contrasted with the FIG. 2 embodiment, as follows. In the FIG. 7 embodiment, the front ends of the side panels are not joined together as they are in the FIG. 2 embodiment. Notably, in the FIG. 7 embodiment, there are no flaps and slits. In the FIG. 7 embodiment the front ends of the two side panels are not joined with one another, so “technically speaking” this is not a three-sided support since there is no third front “side” created by the joined-together end flaps (compare FIG. 2). Hence, this embodiment, lacking a third front side, may be termed (characterized as) “V-shaped”. If the material (e.g., card stock) is stiff enough, the end flaps joining the front ends of the two diverging side panes may not be necessary.

In a manner similar to that of the FIG. 2 embodiment, in the FIG. 7 embodiment the back ends of the side panels are contiguous with one another, forming a “living hinge”. It is intended, of course, that when the support is “assembled”, it is distorted/folded from an initially flat configuration into a 3-dimensional article with the side panels spreading apart from one another.

The “gist” of FIG. 7 is that the support may be effective without requiring flaps at the front ends of the side panels, said flaps being joined together to impart additional stability to the assembled support. It is sufficient that the two side panels are spread apart from one another, so that when a phone is placed on the top edges of the two side panels, the points at which the phone contacts (and is supported by) the side panels are spaced sufficiently apart from one another so that the phone can rest stably thereupon.

FIGS. 8A,B,C,D (collectively referred to as FIGS. 8) are illustrations of an embodiment of a phone support (or stand), according to an embodiment of the invention. In this embodiment, a single flat strip of material such as stiff card stock or plastic has left and right side portions. The two side portions may be “mirror images” of each other. The two side portions may be similar to the previously described side panels, and may be referred to as “side panels” rather than “side portions”.

Each side portion has a notch (groove) extending generally vertically from the top edge thereof towards the bottom edge thereof. The notches are sized to accept a phone being inserted into (and supported by) the notches (grooves), said phone being supported by the two spaced-apart notches (grooves). This feature is similar to the FIGS. 6 prior art where the phone is supported in grooves. The notches (grooves) in the side portions of the FIGS. 8 support may be angled towards the back (center) of the support in the manner shown in FIGS. 6.

In contrast with the FIGS. 6 prior art, this (FIGS. 8) embodiment does not require a “living hinge” between the two side portions. Rather, when “assembling” the support (i.e., manipulating it from its initially flat configuration into a “3-D” configuration suitable for supporting a phone), the front ends of the side portions may be bent (bowed) towards one another so that the two notches (grooves) are opposing one another, spaced apart a distance less than the dimension of the edge (typically bottom edge) of the phone desired to be supported by the side portions.

The material for the support should be sufficiently stiff to be self-supporting and should exert an elastic restoring force after it is bent (bowed) and the phone is inserted into the notches (grooves). This will removably secure the phone in the grooves. When the phone is removed from the support, the support may tend to “spring back” to its original flat configuration.

Deforming the flat template elastically may be contrasted with the “living hinge” of the FIG. 7 embodiment, as follows.

In the FIG. 7 embodiment, there is an upwardly extending back panel against which the phone rests. And, the phone is supported on top edges of the side panels. And, a bump (or incline is provided on the top edges of the side panels to prevent the phone from slipping off of the top edges of the side panels.

In the FIGS. 8 embodiment, there is no upwardly extending back panel against which the phone rests. And, the phone is not supported on top edges of side panels. Rather, the phone is supported by the notches (grooves) extending into the top edges of the side portions. No bump (or incline) on the top edges of the side portions is necessary to prevent the phone from slipping off of the top edges of the side portions. Rather, the combination of notches (grooves) and elastic restoring force provide the desired stability.

The FIGS. 8 embodiment shows only a single pair of opposed notches (one in the left side portion, one in the right side portion). Having only a single pair of opposed notches does not readily allow for adjusting (changing, selecting) the angle at which the phone is supported, as is easily achieved in some of the previous embodiments (particularly when the top edges of the side panels are inclined or angled, such as shown in FIG. 3B).

FIG. 8A shows a template 800 for a phone support comprising a single, flat, elongated, substantially rectangular strip (or panel) 800 of material. The strip of material has two opposite edges or sides 802L and 802R, and a width (W) dimension of approximately 6.5 inches (16.5 cm) between the two sides. The strip of material has a top edge or side 802T opposite a bottom edge or side 802B, and a height (H) dimension of approximately 1.25 inches (3 cm) between the top and bottom sides. The strip 800 may be substantially symmetrical about a centerline (CL) thereof.

A first notch (or groove, or cutout, or slot, or notch) 804L extends into the strip 800 from the top edge 802T towards the bottom edge 804B, and is located near the left side 802L of the strip. A second notch (or groove, or cutout, or slot, or notch) 804R extends into the strip 800 from the top edge 802T towards the bottom edge 804B, and is located near the right side 802R of the strip. The notches (grooves) may have a width (w) of approximately ½ inch (1.25 cm) and a depth (d) of approximately ½ inch (1.25 cm). The depth (d) may be different (greater or lesser) than the width. Indeed, in the illustration of FIGS. 8, the notches (grooves) are each shown as having a depth slightly greater than their width.

The notches (grooves) 804L, 804R are illustrated as extending perpendicularly into the strip 802 from (into) the top edge 802T towards the bottom edge 802B thereof. It should be understood that the notches (grooves) may be angled (compare prior art FIGS. 6) — in other words, one or both sides of a given notch (e.g., 802L) may be angled towards the opposite notch (e.g., 804R), or towards the centerline (CL) of the strip 800 (or 800′).

The width of the notches (grooves) 804L and 804R should be slightly greater then the thickness of a phone (or tablet) intended to be inserted (as discussed below) into the notches (grooves).

The aforementioned dimensions are exemplary, based on typical dimensions of a cell (mobile) phone or tablet for which the support is intended to receive in the notches (grooves) 804L and 804R. An exemplary cell phone is generally rectangular, measuring approximately 7 cm × 15 cm, with a thickness of approximately 6 mm. A generally rectangular phone, typically in the form of a “brick”, typically has four edges, comprising two, opposite, relatively long side edges, and two, opposite, relatively short top and bottom edges.

The strip 800 of material may, for example, comprise card stock having a thickness of approximately 0.5 mm (0.020″) Alternatively, the strip of material may, for example, be plastic having a thickness of approximately 0.25 mm (0.010″). As mentioned previously, the card stock may be a panel of a box, such as a cereal box, a placemat at a fast food establishment, or the like. Cardboard may be preferable to plastic. The material of the strip should be able to be readily bent (bowed) by a user, while exhibiting a restoration force (i.e., elastic deformation). It is not intended that the strip of material be folded (although it may be), as was the case with the previous embodiments (refer, e.g., to FIGS. 1, 2, 5A, 5B). It is intended that the phone support(s) disclosed herein be inexpensive and disposable, and they may not have a long “life expectancy”. In other words, it may be inconsequential if a support gets wrecked by mishandling or extended use.

The strip shown in FIG. 8A is generally rectangular — i.e., a plane figure with four straight sides and four right angles, especially one with unequal adjacent sides, in contrast to a square. Of course, the corners may be rounded, etc.

FIG. 8B shows that the strip 802′ may have a height (H′) halfway across its width which is greater than the height (H) at its (left and right) ends. In other words, the top edge 802T of the strip may not comport to the strict definition of a rectangle in that the top side 802T is not the same as and entirely parallel to the bottom side 802B. Nevertheless, the strip may be considered to be substantially rectangular. The notches (grooves) 804L and 804R, and other aspects of the strip 802′ may be similar or identical to the notches (grooves) and other aspects of the strip 802.

Generally, the top edge 802T of the strip 802, particularly between the two notches (grooves) 804L and 804T may be arbitrarily shaped, since it does not perform an important function in supporting the phone. This may satisfy an aesthetic goal, or may simply provide increased “real estate” for advertising, logos and the like (see FIG. 4). The “enlarged” top edge may indeed function as a back panel, such as has previously been discussed, to provide additional support for a phone leaning backwards.

In FIG. 8B, the grooves (notches) 804L′ and 804R′ are shown angled towards the back (centerline C_{L}) of the support rather than perpendicular to the top edge of the support (FIG. 8A), such as shown in the prior art support of FIGS. 6A,B. The angle may be approximately 10° -40°, and angled notches (grooves) may be applied to the embodiment of FIG. 8A.

As discussed with respect to some previous embodiments (FIGS. 5A, 5B), the strip 802 or 802′ may be removed (by an end user) from a larger sheet of previously-existing material, such as the back of a cereal box, or a placemat, requiring only lines or perforations delineating the support, without requiring any additional materials.

In the main hereinafter, the strip 802 of FIGS. 8 may be used in demonstrating inserting a phone (or tablet) into the notches (grooves) 804L and 804R.

This embodiment of a single piece support works when it is bowed, rather than folded, and exhibits an elastic restoring force which makes the support “want to” straighten itself out, thereby causing it to “grasp” the edge of the phone inserted into the grooves. In other words, a single flat strip of material such as stiff card stock or plastic having two grooves (compare FIGS. 6A,B prior art) may be bent (bowed) and a phone (or tablet) may be inserted into the grooves to be supported by the stand. As used herein, the term “card stock” (or “cardstock”) for the material of the support, in its various embodiments, may refer to any paper-like product, such as paperboard, craft paper, cardboard, and the like. Generally, cardstock (card stock) is a type of paper that is thicker, heavier, and sturdier than normal writing and printing paper, but thinner and more flexible than some other forms of paperboard.

FIG. 8C shows the strip having been bent (bowed, warped, deformed, curved) longitudinally (our of the original plane of the strip) by an end user so that the notches (grooves) 804L and 804R become aligned across from (opposing) one another, out-of-plane with the remaining portion of the strip 802. For example, the notches (grooves) 804L and 804R may be spaced a distance of approximately 4 inches (10 cm) apart from one another when the strip 802 is flat (planar), and may be spaced a lesser distance of approximately 3 inches (7.5 cm) apart from one another when the strip 802 is bent.

FIG. 8C illustrates a situation where it is desired to support the phone horizontally (landscape mode). The phone is inserted by its one of its long sides into the notches (grooves) 804L and 804R will be supported upright or nearly upright on the support 800, to allow convenient hands-free viewing by the user.

Although not shown, by further bending (bowing) the support so that the two opposing notches (grooves) 804L and 804R are closer together, the phone may be supported vertically (portrait mode) by one of its short sides (normally the bottom side) being inserted into the notches (grooves) 804L and 804R. However, this may not be the best way of using the support to support a phone vertically, and may require (i) deeper notches (grooves) in the strip of material, (ii) a commensurately greater height (“H”) dimension of the strip of material, and (iii) a stiffer material. Generally, the embodiments shown and described with respect to FIGS. 1-5 may be better suited to supporting a phone vertically.

Nevertheless, for supporting the phone vertically (portrait mode), the notches (grooves) 804L, 804R should be sufficiently deep and narrow so that the notches (grooves) are spaced a distance of approximately 2 inches (5 cm) apart from one another. Since the bottom edge of the phone is shorter than its longer edge, as contrasted with the lesser bending of the strip in the FIG. 8B holding the phone in a horizontal orientation (landscape mode), for supporting the phone vertically (portrait mode), the notches (grooves) 804L, 804R should be sufficiently deep and narrow so that the grooves are spaced a distance of approximately 2 inches (5 cm) apart from one another. This may cause the strip to fold at an indeterminate location. Thus, it may be beneficial for supporting the phone in such a vertical orientation if the user creases (folds) the strip 802 slightly at or near its centerline, forming a sort of “living hinge”. However, folding the strip may lessen the benefit of elastic deformation securing the strip to the phone.

FIG. 8D is another view of the support with phone, shown in FIG. 8C. Here it can clearly be seen that the single piece support is bowed, as may be contrasted with a single piece support that is bent (or folded, such as in FIG. 2), and as may be contrasted with a two (or more) piece support (hinged) such as shown in the prior art support of FIGS. 6A,B.

FIGS. 8C,D show a phone disposed horizontally on the support, with the long side (edge) of the phone inserted into the grooves of the support.

FIGS. 8E,F (below) show a phone disposed vertically on or with the support, with the short side (edge) of the phone inserted into the notches (grooves) of the support. The short side of the phone may be the bottom edge. Compare the vertical orientations of the phone shown in FIGS. 2, 4. More particularly,

FIG. 8E shows a phone inserted vertically into a single piece support, such as the support shown in FIG. 8A.

FIG. 8F shows a phone resting vertically by its short bottom edge on a surface (e.g., tabletop) and being “balanced” by inserting a single piece support (such as the support shown in FIG. 8A) onto a long side edge of the phone.

FIG. 8E illustrates a situation where a phone is inserted by one of its short sides into the notches (grooves; 804L and 804R) of a bent (bowed) support so that it will be supported upright or nearly upright on the support, to allow convenient hands-free viewing by the user. Because the phone is “on end” (vertical), its center of gravity is higher (with respect to the surface upon which it is being supported) than if the phone were disposed horizontally on the support (as in FIGS. 8C,D). Because of this, it is recommended that the height (“H”, see FIG. 8A) of the single piece support be increase. Also, the notches (grooves) may extend correspondingly deeper into the “higher” support, and should snugly grasp the phone.

A basic difference between this (FIG. 8E) use of the support and the use shown in FIGS. 8C,D is that the support must be bowed (bent) more since the notches (grooves) need to be closer together to “grasp″(retain) the short side of the phone rather than its long side (as in FIGS. 8C,D).

FIG. 8F illustrates that the phone may be balanced with its short bottom side (edge) resting on the surface (e.g., tabletop). Here, a single piece support (such as the support shown in FIG. 8A) may be inserted onto a long side (edge) of the phone, the notches “capturing” the phone at two vertically-displaced locations. Here, the support is also stood on end (rotated 90 degrees), so that it stands vertically on a surface (such as a tabletop). Hence, the “left” and “right” portions having grooves for receiving an edge of the phone are separated vertically apart from one anther rather than being separated horizontally from one another as in FIGS. 8A, 8B. Nevertheless, the “left” and “right” terminology may be used to describe the two portions of the support which when bent (or bowed, as in the FIGS. 8A,B embodiments), present two opposing notches (grooves) to capture an edge of a phone.

Note that the phone is supporting substantially its entire weight, which is in contrast with the horizontal embodiments where the support rests on the surface (such as a tabletop) and the phone is supported by top edges of the side panels (FIGS. 1-5) or side portions (FIGS. 8A-D) of the support. Note also that rather than the bottom edge of the support (i.e., side portions of the support) being disposed on the surface (such as a tabletop), only one “end” (which may be referred to as “front end” of the support in FIG. 8A) is in contact with the surface (e.g., tabletop). To enable the phone being supported at an angle, the end(s) of the support may be angled. This use of the support (supporting the phone vertically with the support mounted to the side edge of the phone) may not be very stable. Inter alia, a phone supported vertically has a high center of gravity, higher than any portion of the support. (Contrast the situation with the embodiments in FIGS. 1-5 where a back panel or portion of the support may be disposed higher than the center of gravity of a phone resting vertically on the support.) To increase stability, two supports may be used, one disposed on each of the long sides of the phone.

Also, when using the support in this manner (to support a phone vertically), the end of at least one of the left and right portions — i.e., the end of the portion which rests on a surface such as a tabletop — may be substantially square. Also, the “height” dimension (“H”) dimension from top edge to bottom edge of the side portions should be substantial (such as greater than in FIGS. 8A,B) to allow for the notches (grooves) to be deeper than required when using the support in the manner of FIG. 8C to support a phone horizontally (landscape). The end of the support contacting the surface (e.g., tabletop) can, of course, be angled, but this may result in a decrease in stability.

By inserting a long (side) edge of the phone appropriately into the cutouts of the vertically-oriented support having one end of one side portion contacting the supporting surface (e.g., tabletop), the phone may be adjusted within the support so that a short (bottom) edge of the phone also contacts the supporting surface so that the phone rather than the support supports the weight of the phone itself. (In the horizontal embodiments, the support supports the weight of the phone.)

In the embodiments presented herein wherein the support is disposed on a surface such as a tabletop, the bottom edge of the support contacting the tabletop may have cutouts or recesses, such as shown in FIG. 1 (cutouts on bottom edge of side panel(s)) and FIG. 4 (dashed line recess on bottom edge of side panel(s)).

In FIG. 8D, the bending (bowing) of the support is more visible than in FIG. 8C.

In these FIGS. 8 embodiments, involving the user bending (deforming, bowing, arcing, flexing) the initially planar strip 802 to orient the grooves opposite from one another, it is desirable that the strip “wants” to straighten itself out after the phone has been inserted into the grooves. This elastic deformation of the strip is beneficial in securing the strip with the phone, stabilizing things.

In these FIGS. 8 embodiments, two notches (grooves) 804L and 804R have been disclosed and discussed. It is within the scope of the invention that more than two grooves may be provided, perhaps a set of two or more “left” notches (grooves) and a corresponding set of two or more “right” notches (grooves), and the different sets of notches (grooves) may have different dimensions. Having multiple sets of notches (grooves) may improve the versatility of the support not only in accommodating phones (or tablets) having different dimensions (mainly, thickness), but also in using the support to support the phone in a horizontal or vertical orientation.

This (FIGS. 8) embodiment may be differentiated from the earlier embodiments of FIGS. 1, 2, 5A, 5B in that there is no hinge, there are no distinct left and right side panels, and the phone is not supported on a top edge of the strip (but rather is supported in the grooves).

This (FIGS. 8) embodiment may be differentiated from the prior art (FIGS. 6) in that there is no hinge, and there are no distinct left and right side panels.

In some of the embodiments disclosed herein, particularly the FIGS. 8 embodiments, it may be beneficial to provide the support separate from a pre-existing object, such as a cereal box or a placemat. For example, a resilient plastic support formed according to the FIGS. 8 embodiments may be provided as an inexpensive give-away item at a merchant or trade show, imprinted with the merchant’s or exhibitor’s information.

FIG. 9 is a photograph of a single piece support for a phone (e.g.), according to an embodiment of the invention. In this embodiment, the single piece support may be bent (bowed) rather than folded. A middle portion (above the dashed line) of the support may be higher, in the manner illustrated in FIG. 8B. The notches may be partially angled. The middle portion has a length (end -to-end) which is less than the length of the overall support. End portions (or extensions) of the middle portion of the support may be provided with “flaps” (or tabs) which are shown folded 90° towards the back of the support, forming what could be termed “extensions” of the respective grooves, which provide additional contact area between the phone and the support and thereby aid in the “mating” of phone and support. The additional contact area is much greater than the very minimal contact area between the phone and support which, in other embodiments that do not have the higher (expanded) middle, the contact area consists of the mere thickness of the cardstock that the support is made of.

FIG. 9A is a photograph (front view) of a phone being supported vertically on a support, such as the support of FIG. 9, according to an embodiment of the invention.

FIG. 9B is a photograph (front view) of a phone being supported vertically on a support, such as the support of FIG. 9, according to an embodiment of the invention.

A phone being supported horizontally by a single piece phone support with “flaps”, such as in the FIG. 9 embodiment, would look much like the arrangement (phone horizontal) as was shown in FIGS. 8C and 8D.

### APPENDICES

Appendix A, incorporated by reference herein, has some photographs, illustrations and diagrams of phone supports made according to some embodiments of the invention. Descriptive text is included, as follows:
(A1) This shows a phone being supported in an upright (portrait orientation) position on a support. Note that the top edges of the panels forming the base portion have features (protrusions, bumps) extending upward to prevent the phone from sliding off of the support. Two of these features are provided to provide corresponding two secure positions (angles) for orienting the phone. The tendency of the phone to want to slide down and off of the support is particularly pronounced when the phone is in an upright (versus) sideway position.
(A2) This is a back view of a 4-sided (rectangular) phone support with a phone being disposed thereupon. Note that there is an upwardly-extending feature on front (distal) end of the base portion to keep the phone from sliding down, and off.
(A3) This is a view of a four-sided support similar to that shown in (A1). Here it can be seen that the forward edges of the sides of the back portion are angled. Also the two upwardly-protruding features on the top edges of the two arms of the base portion are evident. Recall, that an alternative to having these features is that the top edges of the base portion are angled slightly downward, from front -to-back, or the top edges are “wavy”.
(A4) This shows a typical template for a four-sided support. Note the flaps at the ends of the side portions with slits that allow for them to be joined with one another.
(A5) This shows a template for a 3-sided (“triangular”) support. Note the raised features at the front of the two sides, and the flaps with slots for joining the two sides.
(A6) This (photograph) shows a 3-sided support, assembled.
(A7) This (photograph) shows a 3-sided support, assembled, with a phone being supported upon it.

Appendix B, incorporated by reference herein, reprises FIGS. 2A,B,C,D and 3A,B,C of the provisional.

Relative dimensions, vis-à-vis an exemplary phone, may be ascertained from the views in FIGS. 2A-D of the provisional application.

FIGS. 2A,B,C,D are photographs of an early prototype of the invention, and shown supporting a phone in an upright (2C, portrait) or sideways (2D, landscape) orientation..

FIGS. 3A,B,C are photographs of an early prototype of the invention, and show placing a weight in the base of the phone support to add stability.

FIGS. 2A,B,C,D are photographs of a cardboard prototype, wherein the ends of the left and right sides are overlapping and stapled together (rather than the tab/slot arrangement shown in FIG. 1), and also showing that there may be notches (or openings) provided on the bottom of the base to allow a charger cable to be inserted into the phone while it is disposed on the support. See also FIG. 1 which shows a charger cable.

FIGS. 3A,B,C are some photographs of another, similar prototype. This one has a straight (rather than wavy) edge along the top surface of the base. It was found that with a small angle (such as 5°), the phone will “stay put”, without sliding. Also, the top edge of the base is angled upward, from the vertical back of the support to the front of the base. A phone is unlikely to slide off.

These pictures also show the strap extending across the bottom of the base, with coins taped thereto to add weight (lower the center of gravity), making the support more stable.

This illustrates that the base, which forms an open space (volume), may be used to store various objects, such as ear buds. The volume of the base may also improve the acoustics by resonating sound coming from the phone speaker, assuming that the phone is disposed in an upright (profile) position on the support, and the phone’s speaker is at the bottom of the phone).

Document N1 (submitted herewith) shows some prior art techniques for making different styles of mobile phone stands using cardboard (corrugated). These techniques require much cutting, resulting in several different pieces, followed by assembly requiring gluing. In contrast thereto, the present invention provides a single piece of card stock (or plastic) which can be folded into a support (or stand) without requiring gluing.

Document N2 (submitted herewith) shows smartphone stands for home, office, or travel. They all appear to be plastic. Some (2. Omotron, 3. Ugeren, 5. Moko multi-angle, 6. HiTech wireless) appear to be foldable, to some extent, but do not appear to be capable of being folded flat. Some (1. Lamicall, 4. ToBeoneer) appear to be one piece, very 3-dimensional, and not collapsible at all. In contrast thereto, the present invention provides a single piece of card stock (or plastic) which can be folded into a support (or stand), and subsequently unfolded for storage or disposal.

Document N3 (submitted herewith) is a webpage(s) (referenced above) showing a number of phone stands, including the V-fold tablet stand of FIGS. 6A,B. Details at the top of page 9.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. A phone support comprising:
a flat, generally rectangular strip of material having a top edge, a bottom edge and two ends;
a centerline located approximately midway between the two ends defining a left portion on one side of the centerline and a right portion on the other side of the centerline; and
two notches extending into the side portions from the top edge of the strip towards the bottom edge of the strip, one of the notches disposed in the left side portion and another of the notches disposed in the right side portion;
wherein, in use, the strip of material is bent or bowed so that the two notches oppose one another and an edge of a phone can be inserted into the two notches.

2. The phone support of claim 1, wherein:
the material is cardstock.

3. The phone support of claim 1, wherein:
the material is plastic.

4. The phone support of claim 1, wherein:
when assembled, the side portions form a chamber which may amplify sound coming from a speaker of a phone resting in the grooves extending into the top edges of the side portions.

5. The phone support of claim 1, wherein:
the support is defined by lines printed on or perforations formed in a sheet of card stock.

6. The phone support of claim 1, wherein:
the sheet of material is a panel or side of a box.

7. The phone support of claim 1, wherein:
the box is a cereal box.

8. The phone support of claim 1, wherein:
the support is provided as a flat, unassembled template in a retail establishment.

9. The phone support of claim 1, wherein:
the support is provided as a flat, unassembled template in a box, such as a cereal box.

10. The phone support of claim 1, wherein:
in use, the long side edge of a phone is inserted into the two notches.

11. A phone support comprising:
a flat sheet of cardstock suitable to be assembled by folding into a 3-dimensional structure, wherein the assembled structure comprises:
two side panels, each having a back (proximal) end, a front (distal) end opposite the back edges, a top edge and a bottom edge, wherein the two side panels are joined with each other at their back ends forming a living hinge); and
a generally vertical back portion extending upward from the top edges of the side panels;
wherein, in use, the top edges of the side panels support a phone.

12. The phone support of claim 11 wherein:
the top edges of the side panels are straight.

13. The phone support of claim 11, wherein:
the top edges of the side panels are slightly higher at their front (distal) ends and angled towards their back (proximal) ends to counteract a tendency for the phone to slide down and off of the support.

14. The phone support of claim 11, wherein:
the top edges of the side panels are wavy.

15. The phone support of claim 11, wherein:
the top edges of the side panels include bumps extending upward from near their distal ends.

16. The phone support of claim 11, wherein:
when assembled, the side panels form a chamber which may amplify sound coming from a speaker of a phone resting on the top edges of the side panels.

17. The phone support of claim 11, further comprising:
notches formed in the bottom edges of the side panels.

18. The phone support of claim 11, further comprising:
a back panel disposed between the two side panels.

19. The phone support of claim 11, wherein:
the support is defined by lines printed on or perforations in a sheet of card stock.

20. The phone support of claim 11, further comprising:
advertising disposed on at least some surfaces (panels and portions) of the support.
